(19) United States
(12) Patent Application Publication
(10) Pub. No.: US 2026/0349821 A1
(43) Pub. Date: Nov. 5, 2026

(54) COMPUTING ARCHITECTURE WITH PERPETUAL REQUIREMENTS PROCESSING

(71) Applicant: Epicor Software Corporation, Austin, TX (US)

(72) Inventor: Timothy A. Shoemaker, Rapid City, SD (US)

(21) Appl. No.: 19/197,888

(22) Filed: May 2, 2025

(51) Int. Cl. G06F 9/50

(52) U.S. Cl. CPC G06F 9/5038; G06F 9/5033; G06F 2209/5021

(57) ABSTRACT

A system and method for preprocessing updates for an MRP system. A disclosed system includes: receiving an update for a part; creating a queue record in a queue for the update; assigning a priority to the queue record; forwarding a request to the MRP system to generate a part plan for a selected part having a highest priority in the PMRP queue; and removing queue records associated with the selected part from the PMRP queue.

### TECHNICAL FIELD

The subject matter of this disclosure relates to a computing architecture, and more particularly to a computing architecture that provides perpetual requirements processing.

### BACKGROUND

There exist any number of technology platforms that provide automated management for large numbers of resources. Such platforms are typically equipped to receive ongoing updates or changes that impact the different resources. For example, updated demands for, or availability of, any of the resources may be received at any time from any number of internal or external sources. Furthermore, the criteria for managing individual resources can likewise be dynamically altered, e.g., threshold requirements or parameters associated with the various resources can likewise be revised at any time.

Illustrative technology platforms and their associated resources may for example include: distributed computational systems having resources such as cloud based processors, memory and hardware resources; web resources on the Internet; communication infrastructures having resources such as switches, cell towers, routers; software resources; autonomous systems such as self-driving vehicles, robots and drones; Internet of Things (IoT) platforms; energy management systems having resources such as solar cells and windmills; inventory control systems; material requirement planning (MRP) systems, etc. In some instances, the number of different resources being managed within the platform may be tens or hundreds of thousands, which limits the platform's ability to make changes in a real-time fashion as updates are received.

### SUMMARY

Aspects of the disclosure provide a system and method for preprocessing updates for resources being managed by a technology platform.

A first aspect provides a system having a memory and a processor coupled to the memory and configured to preprocess updates for a material requirements planning (MRP) system. The system includes: a first processing thread configured to: receive an update for a part; create a queue record in a perpetual material requirements planning (PMRP) queue for the update; and assign a priority to the queue record. The system further includes a second processing thread configured to: forward a request to the MRP system to generate a part plan for a selected part having a highest priority record in the PMRP queue; and remove queue records associated with the selected part from the PMRP queue.

A second aspect provides a method for preprocessing updates for a material requirements planning (MRP) system, including: receiving an update for a part; creating a queue record in a perpetual material requirements planning (PMRP) queue for the update; assigning a priority to the queue record; forwarding a request to the MRP system to process a selected part having a highest priority in the PMRP queue to generate a part plan; and removing queue records associated with the selected part from the PMRP queue.

Additional aspects may include one or more of the following.

Any one or more of the mentioned aspects, and including examining an attribute in a parts table in the MRP system to determine if the update should be excluded from processing.

Any one or more of the mentioned aspects, and wherein the attribute comprises an exclude flag.

Any one or more of the mentioned aspects, and wherein the queue record comprises a part number, a change type, and a queue priority.

Any one or more of the mentioned aspects, and wherein the queue record further comprises a location, a create date/time, a last change date/time, and a change count.

Any one or more of the mentioned aspects, and wherein the priority is determined from a priority table.

Any one or more of the mentioned aspects, and wherein the priority table includes a list of change types and an associated priority for each change type.

Any one or more of the mentioned aspects, and wherein the priority is further determined based on a tolerance value for the part stored in the MRP system.

Any one or more of the mentioned aspects, and further comprising a third processing thread configured to periodically examine queue records in the PMRP queue and recalculate priorities.

Any one or more of the mentioned aspects, and wherein the second processing thread is configured to evaluate the availability of the MRP system prior to forwarding the request for the selected part.

### BRIEF DESCRIPTION OF THE DRAWINGS

These and other features of this invention will be more readily understood from the following detailed description of the various aspects of the invention taken in con-junction with the accompanying drawings in which:

FIG. 1 shows a technology platform with a perpetual requirements processor according to embodiments.

FIG. 2 shows a material requirement planning (MRP) system with a perpetual MRP processor according to embodiments.

FIGS. 3A and 3B show an illustrative priority table according to embodiments.

FIG. 4 shows a flow diagram of a method for processing part updates for an MRP system according to embodiments.

FIG. 5 shows a set of processes implemented by an orchestrator, according to embodiments.

FIG. 6 shows a computer system, according to embodiments.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Aspects of the present invention provide technical solutions for enhancing a technology platform to allow for continuous and perpetual management of resource-related updates. In any platform that manages large numbers of resources, the ability to respond to an ongoing stream of ad hoc updates in real-time is a technological challenge. For example, when the number of managed resources totals in the tens or hundreds of thousands, and each of the resources is subject to changing requirements at any time, the computational overhead for efficiently processing a constant stream of updated requirements data in real-time can be beyond the capabilities of the platform. Current approaches to processing updates generally utilize scheduled events, e.g., at night or over a weekend when the platform is subject to low demands, at which time collected updates are processed in a batch mode. While certain platforms may allow for the manual processing of a single update during highly active periods, blindly handling large numbers of updates in such a manner is technologically impracticable as the approach would greatly impact performance.

Embodiments disclosed herein provide a technical solution to the aforementioned technical challenges by providing a computerized front-end system and method that “preprocesses” received requirements updates for a technology platform. The front-end system includes an orchestrator and queue, which prioritizes updates and feeds the highest priority updates to the platform in a real-time fashion (e.g., during high activity periods). This accordingly allows for real-time processing of important updates while relegating less important updates to standard batch processing during low demand periods, thus avoiding performance lapses.

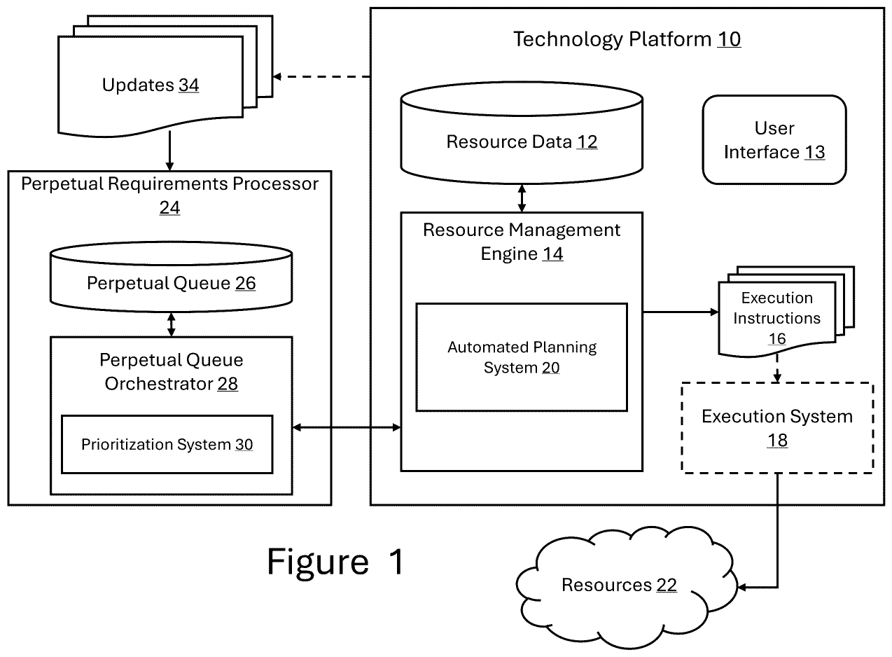

FIG. 1 depicts an illustrative technology platform 10 having a resource management engine 14 that manages the implementation (e.g., deployment, fulfillment, etc.) of large numbers of resources 22 based on resource data 12. Resource data 12 may for example include information about each resource, and activity information such as demand data, availability data, time requirements data, etc. Resource management engine 14 includes an automated planning system 20 that generates execution instructions 16 for each of the managed resources 22 to manage how they are implemented. Execution instructions 16 may, for example, include plans or suggestions that can then be fed to an execution system 18 to automatically execute the instructions. When online, a user interface 13 (or other type of interface) allows users and systems to interface with the platform 10 to perform various planning related tasks.

As noted, resource data 12 may be continuously updated as new resource demands, availability, parameters, etc., are inputted into the technology platform 10. As noted, while automated planning system 20 is generally configured to run updates with batch processing (preferably during low demand periods), it is also capable of processing individual updates manually in an ad hoc manner at any time the platform is operating, including during high activity periods. However, processing every received update in such a manner would not only reduce the computational performance of the platform 10, but would also generate updated execution instructions 16 that are not particularly useful or time critical. Nonethless, it may be desirable to automatically process some updates in a real-time fashion, even during high demand periods.

To address this technological challenge, a front-end to the technology platform 10 is provided that includes a perpetual requirements processor 24 that “preprocesses” updates 34 before being submitted to the technology platform 10, controlling and prioritizing updates in a smart manner. Perpetual requirements processor 24 includes a perpetual queue 26 into which updates 34 are received and a perpetual queue orchestrator 28 processes the queue 26 with a prioritization system 30 to prioritize each of the updates in the queue 26. Orchestrator 28 then submits “requests” associated with the highest priority updates to the automated planning system 20 in a controlled manner, which ensures that the platform 10 does not process unnecessary or an overwhelming number of updates. This also ensures that the computational performance of the platform 10 is maintained at an acceptable level and is not overwhelmed by processing low priority updates.

Perpetual requirements processor 24 may be implemented using any computerized technology. For instance, perpetual queue 26 may be implemented with a database such as a relational database, a hierarchical database, an object-oriented database, etc. Updates 34 may for example be embodied in a structured format such as defined data record types or data object generated from any source, including the platform 10 itself. Orchestrator 28 may, for example, comprise a computer program running on a dedicated processor configured to process data in queue 26 and interact with platform 10 using any type of software, firmware and/or hardware integration. Depending on the application, perpetual requirements processor 24 can be implemented as a stand-alone module or be integrated within technology platform 10. Further, perpetual requirements processor 24 may be configured to run multiple processing threads in parallel.

As noted, technology platform 10 may comprise any computing environment in which large numbers of resources 22 are managed. Examples include distributed computational systems having resources such as cloud based processors, memory and hardware resources; web resources on the Internet; communication infrastructures having resources such as switches, cell towers, routers; software resources; autonomous systems such as self-driving vehicles, robots and drones; Internet of Things (IoT) platforms; energy management systems having resources such as solar cells and windmills; inventory control systems; material requirement planning (MRP) systems, etc.

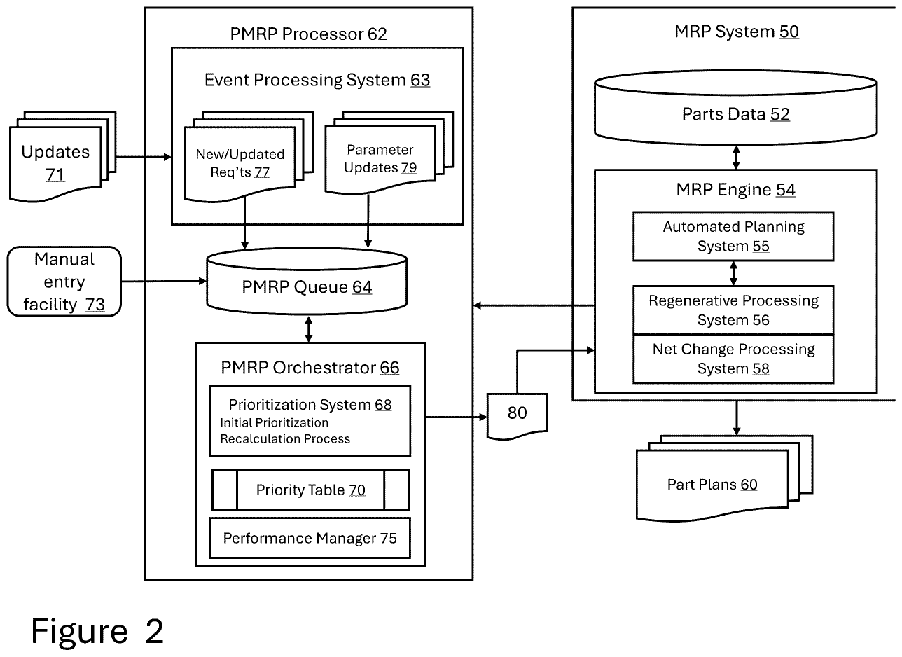

FIG. 2 depicts an illustrative use case in which the technology platform 10 of FIG. 1 is implemented as a material requirement planning (MRP) system 50. MRP is a known computerized planning process used to predict the timing and quantity of materials needed to implement a production process. For example, MRP can be used to develop a production plan for finished items by defining inventory requirements for components and raw materials (i.e., parts). MRP determines what materials are needed, in what quantities, and when they need to be sourced during the production process. The resulting production plan can be utilized by a further automated process to complete the production of the finished items.

As shown, MRP system 50 includes an MRP engine 54 having an automated planning system 55 configured to generate part plans 60 from parts data 52. Traditionally, MRP processing (also referred to as “planning” or “replanning”) has been a scheduled event using a batch processing system 56. Data is collected periodically, including demands (sales orders, jobs, transfer orders), supplies (inventory, future purchase orders, jobs, and transfer orders), and other criteria (e.g., minimum, maximum, and safety stock). This data is processed by the MRP system 50, which for example generates part plans 60 that provide recommendations, advanced scheduling, finite scheduling, precise estimates of completion times, etc.

MRP system 50 is likewise subject to a continuous stream of updates 71, e.g., new orders, changing order, supply changes, etc., which when processed by MRP engine 54, generate new or updated part plans 60. Modern MRP systems typically have two main processing methods for handling updates:
(1) Regenerative: the entire set of MRP updates are completely recalculated.
(2) Net Change: only parts that have had changes are regenerated, leaving the balance of the parts untouched.
   Regardless of the method used, such processing is typically run as a batch process overnight, or over a weekend when system demands are low. At high demand times, e.g., during the day, net change processing system 58 allows for manual on-demand processing for smaller MRP events, i.e., one or several parts at a time. Processing a single part can however take up to a minute and only part can be processed at a time. For this reason, traditional MRP systems are not equipped to process large numbers of events in an “as received” manner (i.e., in a real-time fashion) especially during high demand periods.

In order to allow for processing of individual events (e.g., parts replanning) in a real-time fashion, a perpetual material requirement planning (PMRP) processor 62 is provided, which is configured as a front-end to MRP system 50. PMRP processor 62 generally includes: (1) an event processing system 63 that detects new updates and creates queue records; (2) a PMRP queue 64 that stores the queue records; and (3) a PMRP orchestrator 66 that prioritizes and processes queue records within the queue 64 for planning by MRP system 50.

In various embodiments, event processing system 63 acts as a gatekeeper to exclude some updates 71 from processing by PMRP processor 62. This accordingly ensures that PMRP processor 62 does not waste resources on unimportant updates 71. In certain approaches, event processing system 63 can exclude updates based on one or more tolerance values set for individual parts or classes of parts in the parts data 52. In a typical MRP system 50, parts data 52 includes one or more parts tables that list all the parts being managed and associated attributes. One or more such attributes may include a tolerance value for a part or class of parts. Thus, for example, a part or class of parts might include an “exclude flag” which is an attribute setting that tells event processing system 63 to ignore the update 71 and not enter it into the PMRP queue 64. This may be used to identify parts that simply should be ignored by PMRP processor 62.

Assuming the exclude flag is not set, event processing system 63 determines how to handle the update 71. If the update 71 is for a change type that does not exist, then a new queue record gets created in the PMRP queue 64. If the update is for a change type that does exist, then an existing queue record is located in the queue 64 and is updated. For example, if a quantity or date changed for an existing update already in the queue, the associated queue record would simply be updated. Alternatively, if the update is a new reschedule event, then a new queue record would be created.

Illustrative updates 71 that result in new queue records include new/updated requirements 77 such as a newly created demand for a part (e.g., a sales order, a job material, a transfer order, a forecast, a new master product schedule) or a newly created supply order (e.g., a new job, purchase order, transfer order, etc.). Other types of updates 71 can include parameter updates 79 such as changed part setup data (e.g., an updated minimum, maximum, safety stock, days of supply, etc.).

In an illustrative embodiment, change types that are subject to processing by PMRP processor 62 may for example be categorized as follows:
a. Demand:
   i. Increase—the requested quantity has been increased
   ii. Decrease—the requested quantity has been decreased
   iii. Reschedule in—the demand date has been pulled in.
   iv. Reschedule Out—the demand date has been pushed out.
   v. Late—the date for the delivery of the demand is past due
   vi. Early—the date that the demand was consumed is earlier than scheduled.
b. Supply
   i. Increase—supply order was increased
   ii. Decrease—supply order was decreased
   iii. Scheduled In—the supply order's date was pulled in
   iv. Scheduled Out—the supply order's date was pushed out
   v. Arrived Early—the supply arrived early
   vi. Arrived Late—the supply order is late
   vii. Late—the supply has not arrived yet and is late
   viii. Unplanned quantity adjustment down—on hand quantity was decreased
   ix. Unplanned quantity adjustment up—on hand quantity was increased
   x. Quantity received was higher than expected
   xi. Quantity received was lower than expected
c. Parameter Change:
   i. Minimum quantity change
   ii. Maximum quantity changed
   iii. Safety stock quantity changed
   iv. Order multiple changed
   v. Days of supply changed

Furthermore, other updates that can create a new queue record include a new transaction record being created, e.g., this might add a record to PMRP queue if the transaction was an inventory adjustment or involves any planned transaction that is issued/shipped/received early or late.

As updates 71 are received, they are added to the PMRP queue 64 in the form of queue records. Upon entry into queue 64, PMRP orchestrator 66 analyzes each update 71 with prioritization system 68 to determine an initial priority. In certain cases, the initial priority may later be recalculated, e.g., when a later update is received for the queue record for the same (or related) parts as the already entered. The already entered record and its associated priority may be altered with a recalculation process.

Regardless, prioritization system 68 prioritizes queue records in the queue 64 to determine an order of when such records are to be processed by the MRP system 50, referred to herein as a trigger or triggering event. Based on prioritization of the queue records, PMRP orchestrator 66 accordingly triggers requests 80 (e.g., one or more part numbers and associated sites) to the MRP engine 54 for processing.

In certain embodiments, a priority table 70 is utilized to set a priority for different types of updates 71 (referred to herein as “change types”). In some embodiments, the table 70 is used to assign initial priorities to queue records when received based on the determined change type. Thus, certain change types will have a higher level of priority than others, e.g., new demands within a lead time of a part may have a higher priority than new demands that are outside of the lead time, and supply orders that are rescheduled out may have a lower priority than supply orders that have been rescheduled in. Furthermore, e.g., parameter updates (e.g., min/max/safety values) for parts that have been increased may have a higher priority level than for those that were decreased.

For example, consider a simple data set with three parts, each with supply and demand requirements (assuming a current date of Dec. 31, 2024).
Part-X: Lead Time=30 days
   Sales order #101 for 100 due on Jan. 31, 2025
   Purchase order #201 for 100, delivery date of Jan. 30, 2025
Part-Y: Lead time=30 days
   Sales order #102 for 200 due on Mar. 31, 2025
   Purchase order #202 for 200, delivery date of Mar. 30, 2025
Part-Z: Lead time=30 days
   Sales order #103 for 300 due on Apr. 30, 2025
   On-hand quantity of 300, (available immediately)
      Assume that there are no parts in the PMRP queue 64, and the following updates occur causing three new entries to be added to the queue 64.
Part-X Sales order #101 has a change in schedule to push out the order until February 20
Part-Y Sales order #102 has increased quantity to 225
Part-Z Sales Order #103 has been increased to 325, and rescheduled to January 31.
   Using prioritization system 68, records in the PMRP queue 64 would for example be processed in the following order:
1. Part-Z—because it has an increase in quantity that is closer to the lead time of the part than other parts.
2. Part-Y—increase of quantity has priority over reschedule out suggestions.
3. Part-X—this is last, because it will cause the least impact if it is not processed sooner than the other parts.
   PMRP orchestrator 66 would accordingly submit requests 80 to MRP system 50 for processing in the assigned sequence, thus producing updated part plans 60 in a prioritized fashion.

As noted, PMRP orchestrator 66 can prioritize updates based on a type of update, i.e., “change type,” being made to the part. Prioritization system 68 may for example utilize a schema, such as:
<ChangeType> E.g., a 10 priority ID digit code
<ChangeTypeDesc> E.g., a 50 digit description of the priority ID
<QueuePriority> E.g., an integer value 1-999, 1 being the highest priority
   Accordingly, each update submitted into the PMRP queue 64 can be organized with a change type, a description of the change type and a priority assigned to the change type.

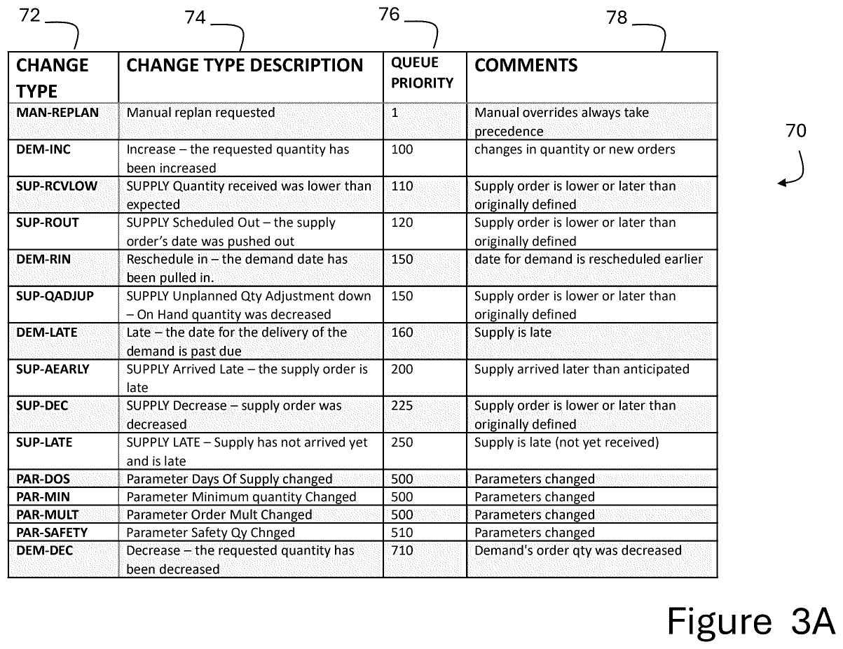

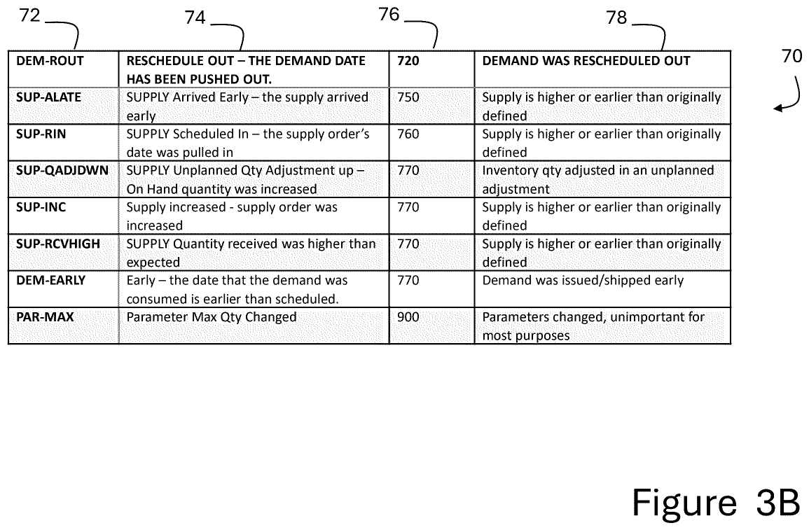

In various embodiments, priority table 70 may for example be implemented or edited by an administrator or developer to define and adjust the priority of various change types. An example table 70 is shown in FIGS. 3A and 3B. Table 70 includes a change type column 72 that lists the various change types, a change type description column 74 that describes each change type, a queue priority column 76 that provides a priority for each change type and a comments column 78 that further describes each change type. Accordingly, each change type 72 has a predefined priority value to assist with queue processing. Although not shown, a further column could include a flag indicating whether the change type should be excluded from PMRP processing.

Other criteria may likewise be used to refine the priority. For example, tolerance values (stored in parts data 52) such as time/date information may be examined when the initial priority is determined and/or at a later time to evaluate and change the priority. For example, a queue record can be evaluated relative to the tolerance values to determine an urgency (e.g., one day late may be okay, but five days late may not be okay). Further, a date/time stamp on queue records can be periodically examined to ensure older records in the queue 64 are processed in due course despite there being “more important” queue records.

Queue records may, for example, use the following schema:
a. Part number
b. Site or location (e.g., a warehouse or production facility)
c. Change type
d. Initial creation date/time of queue record (subsequent record changes for this change type will not change the date)
e. Last change date/time (any subsequent changes to this PRMP queue record will update this date)
f. Change count. (an integer value that will increment with each subsequent change, which allows for higher activity parts to potentially get a higher priority by prioritization system 68)
g. Queue priority (e.g., calculated using priority table 70 or other criteria)
h. Quantity change (e.g., an increase or decrease of demand/supply)
i. Date change (e.g., net days of change, negative moving in or positive moving out)
j. Derived data from other tables (e.g., a Low Level Code used to help sequence the queue).

Any of these fields, along with the priority table 70 and tolerance fields in the parts data 52, may be utilized to facilitate prioritization in the queue 64 by orchestrator 66. For example, “early/late” tolerances fields in parts data 52 may be utilized to hold a number of days of tolerance for a part or class of parts. Thus, assume an update 71 involves a date-related change for an order, e.g., a part order is to be shipped two days late. This late value can be compared to an associated tolerance value for that part to determine whether such a change is important. If yes, the priority can be increased and if no, the priority can be unchanged or decreased. The change count field tracks the number of times a part or relative action for a part has changed based on received updates for the part. If the change count exceeds some tolerance value, the priority for the associated queue record may be increased. Queue record fields and tolerance values can accordingly be leveraged, e.g., as guardrails to ensure PMRP processor 62 does not prioritize immaterial changes and to ensure that certain parts get replanned sooner than later.

Date/time related tolerances may for example include data change type changes, including demand date changes (sales orders, jobs, transfer orders, etc.), and supply date changes (purchase orders, jobs, transfer orders, etc.). They may also include early/late transaction dates such as changed purchase order receipts, job receipts, job issues, and sales order shipments. Other tolerance fields may include, e.g., an early receipt tolerance, which is a number of buffer days that a transaction can be early, or that a supply or demand can be scheduled earlier before replanning. Similarly, a PMRP late receipt tolerance field may include a number of buffer days that a transaction can be late, or that a supply/demand can be scheduled earlier before it triggers a replanning. A PMRP supply rescheduled earlier tolerance field may indicate a number of buffer days a planned supply (purchase order, job, transfer order) can be rescheduled “in” before triggering a replanning. A PMRP supply rescheduled later tolerance field can indicate a number of buffer days a planned supply can be rescheduled “out” before triggering a replanning. A PMRP demand rescheduled earlier tolerance field may indicate a number of buffer days a planned demand (sales order, forecast, job material, transfer order) can be rescheduled “in” before triggering a replanning. A PMRP demand rescheduled later tolerance field may indicate a number of buffer days a planned demand can be rescheduled “out” before triggering a replanning.

As noted, orchestrator 66 may include a queue recalculation process that periodically (e.g., once per day) reprioritizing queue records based on a changing status. For example, when the date has changed, the status of parts may be impacted, e.g., some action that was due “yesterday” for a part would be late as of the date change and therefore need to either be reprioritized for replanning. The recalculation process may for example scan all records to find anything that has become late (e.g., by comparing supply and demand date criteria against the tolerances). When the orchestrator 66 finds a part that falls into these late categories, that part can be reprioritized in PMRP queue 64 for immediate processing by MRP system 50. Other status change examples can include, e.g., a sales order release is late, job material is unissued but late, job finished part is late, purchase order is unreceived and late, operation on a job is late, transfer order shipment is late, transfer order receipt is late, etc.

PMRP orchestrator 66 is accordingly configured to run perpetually, i.e., updates 71 will continuously be entered in the queue 64 and prioritized/reprioritized. PMRP orchestrator 66 will likewise continuously identify and trigger a next part (or set of parts) that are to be processed by MRP system 50. Once identified, PMRP orchestrator 66 triggers a request 80 that will cause a standard MRP net change run for a specific part (or set of parts) on the MRP system 50. MRP net change may replan a single part or a list of parts using standard net change functionality. After a request 80 for a part is sent to MRP system 50 for processing and processing is completed, the PMRP orchestrator 66 will be notified that the process is complete and remove the queue record for the part, as well as all other queue records for the part that was just processed, since replanning by the MRP system 50 resolves all change types for a part. A part can accordingly have multiple entries in the queue 64 (due to different change types), and each should be removed once the part is processed.

PMRP Orchestrator 66 may also include a performance manager 75 that regulates availability (e.g., frequency, volume, etc.) of MRP system 50 to receive requests 80. Performance manager 75 may for example analyze CPU usage of the MRP system 50 and be self-throttling such that real-time replanning does not overly dominate MRP system performance. In other cases, performance manager 75 might dictate a number or frequency of requests that should be sent for processing to MRP system 50, e.g., based on the time/day or other criteria. Further, performance manager 75 can include user settings that allow an end user to control the number of requests being sent to MRP system 50. Further, PMRP Orchestrator 66 can be configured to send a set or dynamically determined number of parts in each request 80, e.g., based on current MRP system availability, send the parts having five highest priority records for replanning.

Furthermore, PMRP processor 62 may include a manual entry facility 73 to allow a user to create manual entries into the PMRP queue 64. This allows a user to run something immediately, e.g., manual entries can be assigned a highest priority to trigger an immediate replanning. Since PMRP processor 62 is constantly triggering real-time net change MRP runs, if someone wanted to run a net change against a part from the MRP system 50, the MRP system 50 may not ever give the user a window to do this (since MRP system 50 may only be able to run one instance at a time). By making it possible to enter a manual entry into the queue 64 in PMRP processor 62, the user can then force a part to be processed in the next PMRP run.

It is understood that PMRP processor 62 can be implemented without any significant logic changes to the MRP system 50. Further, PMRP processor 62 is distinguishable from the traditional processing, which uses a “net change” flag set in parts data 52 to indicate an update associated with the part has occurred. Instead, PMRP queue 64 stores queue records in which a given part may have multiple queue records in the queue 64 that can potentially be processed for replanning.

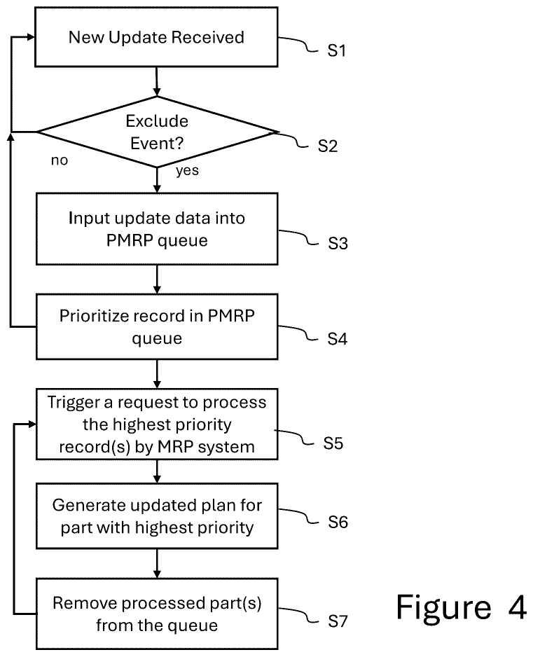

FIG. 4 depicts a flow diagram of an illustrative process for utilizing PMRP processor 62. At S1, a new update is received and at S2 a determination is made whether the update comprises an exclude event (e.g., has an exclude flag set as an attribute). If the update is an exclude event, then the process loops back to S1 for a next update. If the update is not an exclude event, the data associated with the update is inputted into the PMRP queue 64 as a new queue record (or updates an existing record) at S3. Next, at S4, the record is analyzed and prioritized by the orchestrator 66. The process then loops back to S1 to process the next update.

In an ongoing fashion, the orchestrator 66 triggers a request 80 to the MRP system to process the highest priority record(s) at S5. At S6, the MRP system 50 generates an updated plan for the part(s). Finally, at S7, the processed part(s) is removed from the queue 64, and the process loops back to S5.

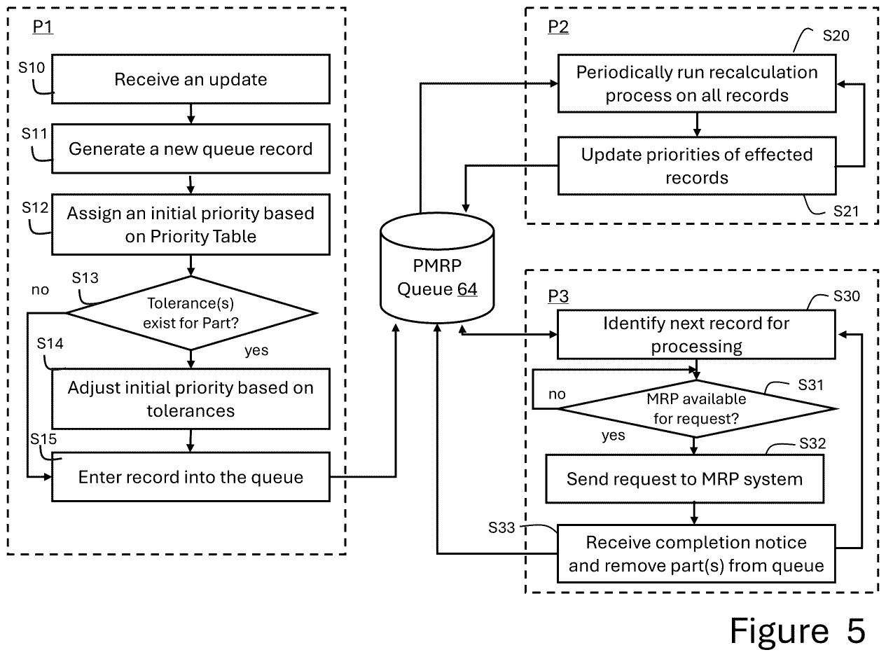

FIG. 5 depicts an illustrative embodiment of three parallel operations (i.e., processes P1, P2, and P3) performed by orchestrator 66. In certain aspects, each of the three processes P1, P2 and P3 may run on three different computing threads in the PMRP processor 62, i.e., they may all run in parallel.

Process P1 is responsible for loading and initially prioritizing records in the queue 64, and includes the following steps. At S10, an update is received, and a new queue record is generated at S11. At S12, an initial priority is assigned to the record based on the priority table 70. At S13, a determination is made as to whether one or more tolerance attributes exist for the associated part based on an examination of parts data 52 in the MRP system 50. If yes, then the initial priority is adjusted as needed based on the tolerance(s) at S14. The queue record (whether tolerance adjusted or not) is then placed into the queue 64.

A second process, P2, periodically runs a recalculation process on the entire queue at S20 and priorities of effected records are updated at S21. Recalculation may for example look how long each record has been in the queue, and, e.g., increase the priority of records that have been in the queue past a threshold amount of time. Recalculation may also look at queue record fields and associated tolerances for parts or classes of parts to see if priorities should be adjusted based on updates to the records.

A third process, P3, identifies a next record (or set of records) for processing by MRP system 50 at S30, e.g., by identifying the record(s) with the highest priority. At S31, a determination is made whether MRP system 50 is available to receive an associated request. For example, if MRP system 50 is currently processing a previous request, or the CPU performance of MRP system 50 is below a threshold (as determined by performance manager 75), then S31 is “no” and the process loops, i.e., waits until MRP system 50 is available. If yes at S31 (i.e., MRP system 50 is available), then the request is sent to MRP system 50 at S32. At S33, the orchestrator waits for a completion notice from MRP system 50 that the request has been processed and then removes all records associated with the part from the queue 64. The process then loops back to S30 to identify the next queue record(s) for processing.

It is understood that traditional batch processing by MRP system 50 may be implemented at anytime independently of PMRP processor 62. When this occurs, the PMRP queue 64 can be automatically cleared by the PMRP orchestrator 66.

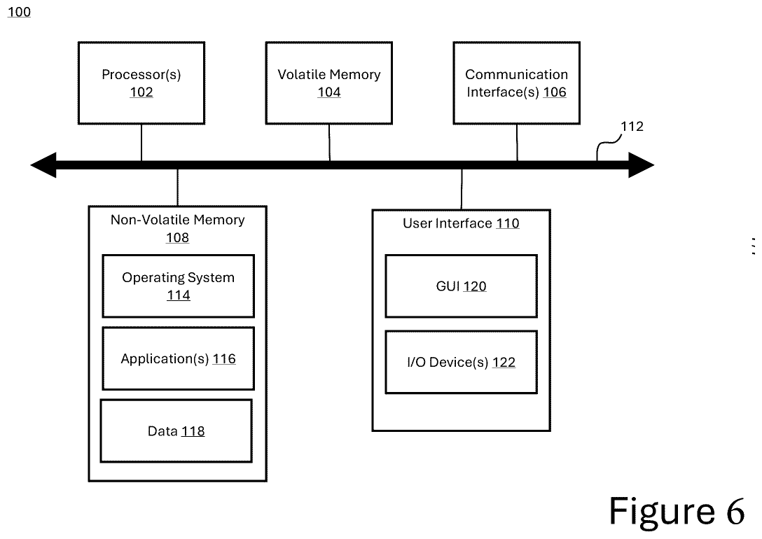

Elements of the described PMRP processor 62 may be embodied in a computing device 100 (separate from MRP system 50), such as that shown in FIG. 6. Computing device 100 may include one or more processors 102, volatile memory 104 (e.g., RAM), non-volatile memory 108 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 110, one or more communications interfaces 106, and communication bus 112. User interface 110 may include graphical user interface (GUI) 120 (e.g., a touchscreen, a display, etc.) and one or more input/output (I/O) devices 122 (e.g., a mouse, a keyboard, etc.). Non-volatile memory 108 stores operating system 114, one or more applications 116, and data 118 such that, for example, computer instructions of operating system 114 and/or applications 116 are executed by processor(s) 102 out of volatile memory 104. Data may be entered using an input device of GUI 120 or received from I/O device(s) 122. Various elements of computing device 100 may communicate via communication bus 112. Computing device 100 as shown in FIG. 6 is shown merely as an example, as clients, servers and/or appliances and may be implemented by any computing or processing environment and with any type of machine or set of machines that may have suitable hardware and/or software capable of operating as described herein.

Processor(s) 102 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 106 may include one or more interfaces to enable computing device 100 to access a computer network such as a LAN, a WAN, or the Internet through a variety of wired and/or wireless or cellular connections.

In described embodiments, a first computing device 100 may execute an application on behalf of a user of a client computing device (e.g., a client), may execute a virtual machine, which provides an execution session within which applications execute on behalf of a user or a client computing device (e.g., a client), such as a hosted desktop session, may execute a terminal services session to provide a hosted desktop environment, or may provide access to a computing environment including one or more of: one or more applications, one or more desktop applications, and one or more desktop sessions in which one or more applications may execute.

As will be appreciated by one of skill in the art upon reading the following disclosure, various aspects described herein may be embodied as a system, a device, a method or a computer program product (e.g., a non-transitory computer-readable medium having computer executable instruction for performing the noted operations or steps). Accordingly, those aspects may take the form of an entirely hardware embodiment, an entirely software embodiment, or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

What is claimed is:

1. A system, comprising:
a memory; and
a processor coupled to the memory and configured to preprocess updates for a material requirements planning (MRP) system, the processor implementing:
a first processing thread configured to:
receive an update for a part,
create a queue record in a perpetual material requirements planning (PMRP) queue for the update, and
assign a priority to the queue record; and
a second processing thread configured to:
trigger a request to the MRP system to generate a part plan for a selected part having a highest priority record in the PMRP queue, and
remove queue records associated with the selected part from the PMRP queue.

2. The system of claim 1, wherein the first processing thread initially determines whether the update should be excluded from processing.

3. The system of claim 2, wherein the update is excluded if an attribute in a parts table in the MRP system for the part comprises an exclude flag.

4. The system of claim 1, wherein the queue record comprises a part number, a change type, and a queue priority.

5. The system of claim 4, wherein the queue record further comprises a location, a create date/time, a last change date/time, and a change count.

6. The system of claim 1, wherein the priority is determined from a priority table.

7. The system of claim 6, wherein the priority table includes a list of change types and an associated priority for each change type.

8. The system of claim 7, wherein the priority is further determined based on a tolerance value for the part stored in the MRP system.

9. The system of claim 1, further comprising a third processing thread configured to periodically examine queue records in the PMRP queue and recalculate priorities.

10. The system of claim 1, wherein the second processing thread is configured to evaluate an availability of the MRP system prior to triggering the request for the selected part.

11. A method for preprocessing updates for a material requirements planning (MRP) system, comprising:
receiving an update for a part;
creating a queue record in a perpetual material requirements planning (PMRP) queue for the update;
assigning a priority to the queue record;
forwarding a request to the MRP system to generate a part plan for a selected part having a highest priority record in the PMRP queue; and
removing queue records associated with the selected part from the PMRP queue upon generation of the part plan.

12. The method of claim 11, further comprising initially determining whether the update should be excluded from processing.

13. The method of claim 12, wherein the update is excluded if an attribute in a parts table in the MRP system for the part comprises an exclude flag.

14. The method of claim 11, wherein the queue record comprises a part number, a change type, and a queue priority.

15. The method of claim 14, wherein the queue record further comprises a location, a create date/time, a last change date/time, and a change count.

16. The method of claim 11, wherein the priority is determined from a priority table.

17. The method of claim 16, wherein the priority table includes a list of change types and an associated priority for each change type.

18. The method of claim 17, wherein the priority is further determined based on tolerance a value for the part stored in the MRP system.

19. The method of claim 11, further comprising periodically examining queue records in the PMRP queue to recalculate priorities.

20. The method of claim 19, further comprising evaluating availability of the MRP system prior to forwarding the request for the selected part.
